(19) United States
(12) Patent Application Publication
(10) Pub. No.: US 2026/0148337 A1
(43) Pub. Date: May 28, 2026

(54) SYSTEMS AND METHODS FOR REFORMATTING ASPECT RATIOS OF DIGITAL IMAGES

(71) Applicant: GOOGLE LLC, Mountain View, CA (US)

(72) Inventors: Yicong Tian, Mountain View, CA (US); Jiachen Wang, Mountain View, CA (US); Xiaohang Li, Saratoga, CA (US)

(21) Appl. No.: 18/958,646

(22) Filed: Nov. 25, 2024

(51) Int. Cl. G06T 3/4046

(52) U.S. Cl. CPC G06T 3/4046

(57) ABSTRACT

A method for reformatting a source image having a first aspect ratio, the method comprising: receiving the source image; generating, based on the source image, an intermediate image having a second aspect ratio different from the first aspect ratio, wherein generating the intermediate image includes using a generative artificial intelligence model to expand the source image in at least one dimension; and generating a third image having a third aspect ratio different from the first aspect ratio and second aspect ratio, wherein generating the third image includes pruning the intermediate image in at least one dimension.

### FIELD OF TECHNOLOGY

The present disclosure relates to techniques for processing digital images, and more specifically to techniques that use generative artificial intelligence to reconfigure/reformat aspect ratios of digital images while maintaining image quality.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In various scenarios, there is a need to change the aspect ratio of a digital image. In mobile-based digital advertising, for example, assets (i.e., images that serve as ads or portions of ads) with portrait aspect ratios that take advantage of the full screen of mobile devices can deliver a more engaging user experience than assets with landscape aspect ratios. While advertisers can directly generate portrait image assets, the time and cost required to conceive and produce such assets can be significant. Thus, some conventional techniques instead generate portrait assets from existing assets with other (e.g., landscape) aspect ratios, by automatically reconfigure/reformat the aspect ratio of the source image to a new aspect ratio.

However, it can be difficult to reformat the aspect ratios of images without sacrificing image quality. For example, some such techniques can produce artifacts and/or generate images with “dark regions” that degrade image quality.

### SUMMARY

In the disclosed techniques, a system generates new images by reformatting a source image that has a first aspect ratio into a new image with a different aspect ratio. Rather than reformat a source image from a first aspect ratio directly to a desired, second aspect ratio, the disclosed techniques generate a second, intermediate image having an intermediate aspect ratio, and then crop/prune the second image in at least one dimension to generate a third (e.g., final) image in the desired aspect ratio. More specifically, this is accomplished by (1) using a generative artificial intelligence model (e.g., a masked generative image transformer (MaskGit) model) to expand the source image in at least one dimension, thereby creating an intermediate image having a second aspect ratio different from the first aspect ratio of the source image (e.g., a 1:1 aspect ratio); and then (2) generating a third image having a third aspect ratio (different from the first and second aspect ratios), at least by pruning the intermediate image in at least one dimension. In this manner, the disclosed techniques can better preserve image quality. In particular, the disclosed techniques can mitigate “dark region” problems with the new image in the new aspect ratio.

Other advantages will also become apparent to one of ordinary skill in the art upon reading this disclosure and viewing the corresponding drawings.

In one aspect, a computing system for reformatting a source image having a first aspect ratio comprises one or more processors and one or more non-transitory memories that have stored thereon computer-executable instructions. The instructions cause the processors to receive the source image and generate an intermediate image that has a second aspect ratio that is different from the first aspect ratio. The intermediate image is generated using a generative artificial intelligence model to expand the source image in at least one dimension. A third image is generated that has a third aspect ratio that is different from the first or second aspect ratio, which is generated including pruning the intermediate image in at least one dimension.

In another aspect, a computer-implemented method for reformatting a source image having a first aspect ratio comprising receiving the source image, generating an intermediate image based on the source image, that has a second aspect ratio and is generated using a generative artificial intelligence model to expand the source image in at least one dimension, and generating a third image that has a third aspect ratio that is different from the first or second aspect ratios and includes pruning the intermediate image in at least one dimension.

In another aspect, one or more non-transitory, computer-readable media store instructions that, when executed by one or more processors, cause the one or more processors to: (1) receive a source image having a first aspect ratio; (2) generate, based on the source image, an intermediate image having a second aspect ratio that is different from the first aspect ratio, wherein generating the intermediate image includes using a generative artificial intelligence model to expand the image in ate last one dimension; and (3) generating a third image having an aspect ratio that is different from the first and second aspect ratios, wherein generating the third image includes pruning the intermediate image in at least one dimension.

### BRIEF DESCRIPTION OF THE DRAWINGS

FIG. 1 is a block diagram of an example system in which techniques for reformatting aspect ratios of images may be implemented.

FIG. 2 depicts an example process for reformatting a source image which may be implemented by the computing system of FIG. 1.

FIG. 3 depicts a specific example implementation of the process of FIG. 2.

### DETAILED DESCRIPTION OF THE DRAWINGS

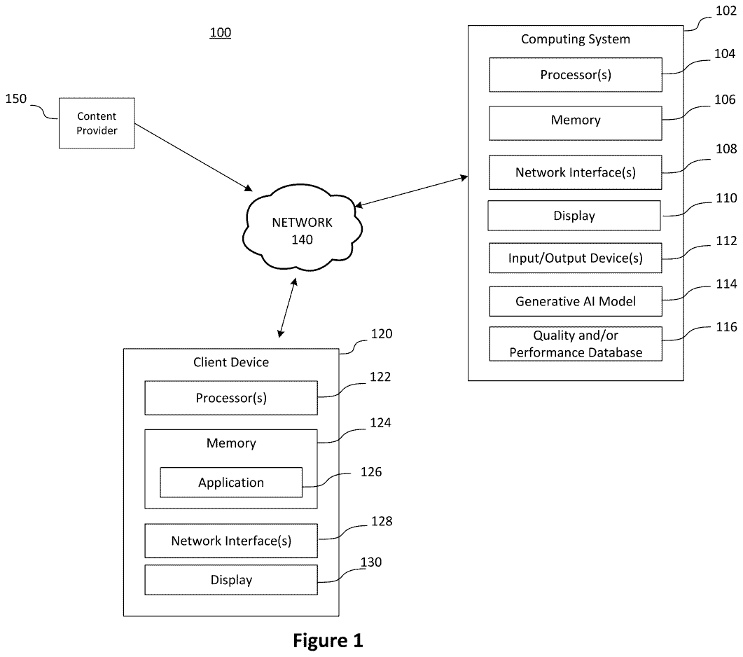

FIG. 1 is a block diagram of an example system 100 in which techniques for reformatting source images can be implemented. The example system 100 includes a computing system 102, a client device 120, a content provider 150 (e.g., a server of a content provider), and a network 140. The computing system 102 is remote from the client device 120 and content provider 150 and is communicatively coupled to the client device 120 and content provider 150 via the network 140. In some implementations, the system 100 does not include client device 120 and/or content provider 150.

The network 140 may be a single communication network (e.g., the Internet), and in some implementations also includes one or more additional networks. As just one example, the network 140 may include a cellular network, the Internet, and a server-side local area network (LAN). While FIG. 1 shows only a single client device 120 and single content provider 150, it is understood that the computing system 102 may also be in communication with a number (e.g., millions) of other client devices that are generally similar to the client device 120, and/or in communication with a number (e.g., thousands) of other content providers that are generally similar to content provider 150.

Generally, computing system 102 can perform image reformatting services (e.g., for providers such as content provider 150). As the term is used herein, an “image” may be a stand-alone image or a single frame of a video (e.g., with the disclosed techniques being repeated for each of multiple video frames), for example.

In a digital advertising or marketing context, for example, computing system 102 may use existing images from content providers (e.g., advertisers) such as content provider 150 to generate new images that the content provider can use in additional digital advertising. As the terms are used herein, transforming a first image into a second image (e.g., with a different aspect ratio) can be referred to as “generating” the second image, or as “reformatting” the first image. As another example, “generating a new image from a source image” may also be described as “modifying” or “reconfiguring” the source image.

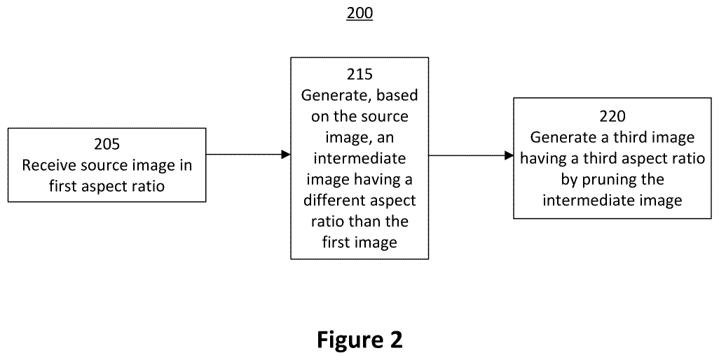

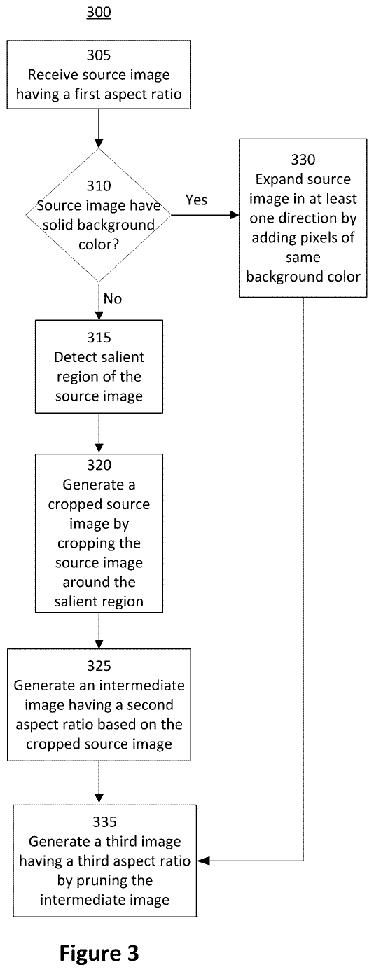

In one such example, the new/additional images can be used to provide a greater diversity of images/advertisements, the performance of which can then be measured (e.g., based on click-through rate, conversion rate, etc.) to determine which images/advertisements are most effective. As another digital advertising example, the new/additional images may have aspect ratios different from the original image, making the new images better suited to ad slots (e.g., in a web page or mobile application) that have different aspect ratio constraints. Notably, the techniques described herein (e.g., in connection with FIGS. 2 and 3) can change the aspect ratio of the source image in a more seamless manner than conventional techniques (e.g., using the GAN uncropping model).

As another example, computing system 102 may generate new images/copies that are intended to facilitate viewer understanding (e.g., images for instructional materials), where performance is measured (e.g., by computing system 102 or another computing system not shown in FIG. 1) by way of determining what proportion of viewers take certain actions upon viewing the images. Other contexts are also possible. For ease and consistency of explanation, however, this disclosure primarily uses examples that are related to a digital advertising implementation/context.

The client device 120 is generally configured to access information resources (e.g., web pages and/or user interfaces of mobile applications or other applications) that can present the images generated by computing system 102. For example, computing system 102 may generate digital advertisements that include (or consist entirely of) the reformatted images discussed herein. Computing system 102 or another computing system may then serve the digital advertisements to users of client device 120 and/or other similar client devices using suitable techniques, such as conducting auctions (e.g., auctions based on keyword bids by advertisers, relevancy metrics, etc.). The digital advertisements may be served in slots of web pages visited by the users, and/or slots of application user interfaces displayed to the users, etc.

The content provider 150 generally may commission or request that computing system 102 reformat one or more images, and/or may provide the source image(s) upon which the image reformatting is based. For example, content provider 150 may be a digital advertiser who provides a digital advertisement image for each of a number of offered products or services, as part of one or more advertising campaigns owned or managed by content provider 150. As other examples, the source image may be a screenshot of a web page hosted by content provider 150, a screenshot of a mobile application that content provider 150 offers, and so on.

Computing system 102 may be a single computing device (e.g., server) at a single location, or may include multiple, coordinating computing devices that are either co-located or remotely distributed. The computing system 102 includes a processor 104, memory 106, network interface 108, display 110, input/output device(s) 112, and a generative AI model 114.

The processor 104 may be a single processor (e.g., a central processing unit (CPU)), or may include multiple processors (e.g., multiple CPUs, or one or more CPUs and one or more graphics processing units (GPUs)).

The memory 106 are a computer-readable, non-transitory storage unit or device, or collection of such units/devices, that may include persistent and/or non-persistent memory components. The memory 106 stores instructions executable by processor 104 to perform various operations, including the instructions of various software applications and the data generated and/or used by such applications.

Memory 106 can also store generative artificial intelligence (AI) models. In particular, in the example system 100 of FIG. 1, memory 106 may store the generative AI model 114 used by processor 104 in the process of reformatting images, as discussed in further detail below. More generally, it is understood that, in some implementations, memory 106 may include one or more additional modules/elements not shown in FIG. 1, such as modules that facilitate serving images (e.g., digital advertisements) to users of devices such as client device 120. In some implementations, the generative AI model 114 is not stored in memory 106, and instead is stored in one or more remote servers or other computing systems. For example, one or more of model 114 may be remotely accessed (e.g., as a cloud service) by computing system 102 to perform the operations of generative AI model 114 discussed herein.

The network interface 108 includes hardware, firmware, and/or software configured to enable the computing system 102 to exchange electronic data with the client device 120 and other, similar client devices (and possibly content provider 150, etc.) via the network 140. For example, the network interface 108 may include a wired or wireless router and a modem.

The client device 120 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, client device 120 includes a processor 122, memory 124, a network interface 128, and a display 130. The processor 122 may be a single processor or may include multiple processors.

Memory 124 includes one or more computer-readable, non-transitory storage units or devices, which may include persistent and/or non-persistent memory components. The memory 124 stores instructions that are executable by processor 122 to perform various operations, including the instructions of various software applications and the data generated and/or used by such applications.

In the example system 100 of FIG. 1, memory 124 stores at least an application 126. Generally, application 126 is executed by processor 122 to provide one or more user interfaces via display 130, where the user interface(s) enable a user to access information resources that can include images reformatted by computing system 102. For example, application 126 may be a web browser application, and images generated by computing system 102 may be included in content slots of web pages visited by the user and presented on display 130. As a more specific example, the images may be digital advertisements that are generated (e.g., reformatted) by computing system 102, and then selected and provided to client device 120 by computing system 102 (or by another computing system) for insertion in the content slots. In other implementations, application 126 is a dedicated application (e.g., a “mobile app”), and images generated by computing system 102 are included in content slots of user interfaces that are presented by the application 126 on display 130.

The display 130 includes hardware, firmware, and/or software configured to enable a user to view visual outputs of the client device 120, and may use any suitable display technology (e.g., LED, OLED, LCD, etc.). In some implementations, the display 130 is incorporated in a touchscreen having both display and manual input capabilities. Moreover, in some implementations where the client device 120 is a wearable device, the display 130 is a transparent viewing component (e.g., lenses of smart glasses) with integrated electronic components. For example, the display 130 may include micro-LED or OLED electronics embedded in lenses of smart glasses.

The network interface 128 includes hardware, firmware, and/or software configured to enable the client device 120 to exchange electronic data with the computing system 102 via the network 140. For example, the network interface 128 may include a cellular communication transceiver, a WiFi transceiver, and/or transceivers for one or more other wired and/or wireless communication technologies.

While FIG. 1 shows client device 120 as a single component communicating directly (i.e., via network 140) with the computing system 102, in some implementations the subcomponents of client device 120 shown in FIG. 1 are instead divided among two or more user-side devices. As just one example, a pair of smart glasses may include the processor 122, the memory 124, and the display 130, while a smartphone may include another processing unit, another memory, another display, and the network interface 128. The smart glasses may then communicate as needed with the smartphone (e.g., via Bluetooth) to enable the operations described herein.

Returning to the computing system 102, the generative AI model 114 generally operates by processing a source image (e.g., from memory 106, or received directly from content provider 150, etc.) to generate another image, with the generated image being expanded in at least one dimension relative to the source image (i.e., with the generative AI model 114 synthesizing new image content to fill the expanded area). In some implementations, the generative AI model 114 is a masked generative image transformer model (MaskGit). In other implementations, the generative AI model 114 is a pixel diffusion model, a latent diffusion model, a regular (non-latent) diffusion model, or another suitable type of image generation model.

In some implementations, as discussed in further detail below, the generative AI model 114 utilizes reinforcement learning and/or other feedback mechanisms to improve/finetune the operation of the AI model. In such implementations, the generative AI model 114 obtains image quality and/or performance data. The computing system 102 may generate the quality and/or performance data or obtain (e.g., receive) the image quality and/or performance data from another system or device, depending on the implementation. In the example system 100 of FIG. 1, the image quality and/or performance data is stored in a quality and/or performance database 116. The image quality and/or performance data may be of any format or type that is suitable to indicate performance in the desired context. In a digital advertising context, for example, the image quality and/or performance data/indicators may include manually generated scores (e.g., based on human review of images), scores generated by the computing system 102 or another system or device (e.g., based on predictive machine learning model(s)), or measured or predicted performance metrics such as click-through rate (CTR) or conversion rate (CVR), etc. As a more specific example, the image quality and/or performance data/indicators may include, for each image, a set scores (whether manually or computer generated) that include an aesthetic score (e.g., how “professional” an image looks), a performance score (e.g., how well the image performs in the desired context), and a relevance score (e.g., how relevant the image is to information that an advertiser wishes to promote).

FIG. 2 depicts an example process 200 for reformatting a source image to have a different aspect ratio. The process 200 may be implemented by the computing system 102 of FIG. 1 (e.g., by processor 104), or by another suitable application and/or computing system. For ease of explanation, the process 200 is explained below with reference to elements of the example system 100 of FIG. 1.

At stage 205, a first image may be received by computing system 102. The first image is in a first aspect ratio, such as landscape, e.g., 3:2 or 16:9. Alternatively, the source image may be in a different aspect ratio, including a portrait aspect ratios, e.g., 9:16 or 4:5, or a square aspect ratio, e.g., 1:1. The source image may be stored in memory 106 and displayed on display 110 of the computing system.

At stage 215, the computing system 102 (e.g., executing or accessing generative AI model 114) may generate an intermediate image that has a second aspect ratio different from the first aspect ratio of the source image. The second aspect ratio may be, for example, a square aspect ratio (1:1). The computing system 102 may expand the source image, using the generative AI model 114, in at least one dimension, e.g., by adding pixels to the top and/or bottom of the image, or to one or both sides of the image, to generate the intermediate image. In some implementations and/or scenarios, the computing system 102 generates the intermediate image by expanding the source image in more than one dimension, e.g., at the top and/or bottom of the source image and also on one or both sides (left and/or right side) of the source image.

Generally, the generative AI model 114 can learn the patterns and structure of a given dataset (a set of training images) and then generate new data (new images) with similar characteristics. In some implementations, the generative AI model treats an image as a sequence of tokens and decodes the image sequentially, i.e., line-by-line. In other implementations, however, the generative AI model 114 is (or includes) a MaskGit model that, during training, learns to predict randomly masked tokens by attending to tokens in all directions, rather than sequentially. When generating an image, the MaskGit model may generate all tokens of an image simultaneously, and then refine the output image iteratively based on the previous generation.

At stage 220, the computing system 102 generates a third image by pruning/cropping the intermediate image to produce an image with a desired aspect ratio, which is different from the first and second aspect ratios. For example, the source image aspect ratio may be 16:9, the intermediate image aspect ratio may be 1:1, and the third/new image aspect ratio may be 9:16. Pruning the intermediate image may include removing pixels (e.g., rows and/or columns of pixels) from one or more edges of the image, such as by pruning the top and/or bottom of the intermediate image, and/or pruning the left and/or right side of the intermediate image.

In some implementations, the computing system 102 determines which areas/pixels to prune by using simple rules, such as pruning each side of an image equally around the image center. In other implementations, more complex rules may be used, such as preferentially pruning the sides of the source image that were not expanded by the generative AI model 114. For example, if the generative AI model expanded the source image at the top and bottom to create a 1:1 aspect ratio, the left and right sides of the source image may be pruned to generate a third image, or vice versa. In still other implementations, one or more additional ML models may be used, such as an ML model that detects salient regions of an image, and the computing system 102 may preferentially prune pixels (e.g., lines of pixels) that are not included in any area identified as salient (or any area with at least a threshold saliency score, etc.).

FIG. 3 depicts a more specific implementation (process 300) of the process 200 illustrated by FIG. 2. Like the process 200 of FIG. 2, the process 300 may be implemented by the computing system 102 of FIG. 1 (e.g., by processor 104), or by another suitable application and/or computing system. Again, for ease of explanation, the process 300 is explained below with reference to elements of the example system 100 of FIG. 1.

At stage 305, similar to stage 205 of FIG. 2, a source image that has a first aspect ratio may be received at the computing system 102. Similar to stage 205, the source image may be in any suitable aspect ratio.

At stage 310, the computing system 102 may use (e.g., locally run or remotely access) a machine learning model (not shown in FIG. 1) to determine whether the source image has a solid background (e.g., with pixel color and/or intensity variation being below some threshold(s)). If the determination in stage 310 is that the source image has a solid background, the process proceeds to stage 330. If the determination is that the source image does not have a solid background, the process proceeds to stage 320. By making this determination at stage 310, the computing system 102 avoids reformatting images with solid backgrounds, which can lead to unwanted or undesirable artifacts or lower image quality.

At stage 315 (e.g., in response to determining that the source image does not have a solid background color), the computing system 102 identifies one or more salient regions of the source image. The computing system 102 may use (e.g., locally implement or remotely access) any suitable computer vision technique (e.g., object detection and/or recognition) and/or machine learning model (e.g., a convolutional neural network) to identify the salient region(s).

At stage 320, the computing system 102 generates a cropped source image by cropping the image around the salient region (i.e., removing portions of the image that are outside the salient region). For example, if stage 315 included detecting one or more background objects, stage 320 may include removing the object(s) in order to allow the generative AI model 114 (at stage 325, discussed below) to generate an intermediate image with a better type(s) or variety of background objects. As another example, if stage 315 included detecting overlays such as text or buttons/controls, stage 320 may include removing such object(s). In other examples, stage 315 more generally identifies less-salient regions (not necessarily objects, etc.), and stage 320 removes those less-salient regions in order to focus more on the central subject and/or theme of the source image.

At stage 325, the generative AI model 114 generates an intermediate image that has a second aspect ratio that is different from the aspect ratio of the source image. In some implementations, the second aspect ratio is a square aspect ratio, i.e., 1:1. The generative AI model 114 generates the intermediate image at least in part by expanding the source image in at least one dimension, e.g., pixels may be added to the top and/or bottom of the source image, and/or to the left and/or right sides of the source image, to generate the intermediate image.

At stage 330 (e.g., in response to the determination at stage 310), the computing system 102 may instead expand the source image by simply adding more lines of the solid background color to the source image. The computing system 102 may add lines of pixels having the same color as the solid background to any side(s)/edge(s) of the source image to produce the desired aspect ratio of the third/new image. As the term is broadly used herein, “color” may refer to the color, shading, and/or intensity of an image or image portion. In some implementations, once the same color pixels have been added to the source image, the process 300 may be complete, i.e., the color padded image may be the final image. In other implementations, the image with same color pixels may be considered the “intermediate” image, and the process 300 may continue to stage 335 where the intermediate image is pruned to generate a third image having a third aspect ratio. In some implementations either of these process flows is possible, based on one or more factors such as the desired final aspect ratio of the image.

At stage 335, the computing system 102 generates a third image of a third (desired) aspect ratio by pruning the intermediate image in a manner that achieves that aspect ratio. The third aspect ratio is different from the first and second aspect ratios. Similar to stage 220, the third image could have an aspect ratio of 9:16 or 3:4, where the source image aspect ratio is 16:9 or 4:3 (respectively) and the intermediate image aspect ratio is 1:1, for example. In another example, the third image could have an aspect ratio of 16:9 or 4:3, where the source image aspect ratio is 9:16 or 3:4 (respectively) and the intermediate image aspect ratio is 1:1 Pruning the intermediate image may include removing lines/pixels in any of the ways discussed above in connection with FIG. 2, for example.

Each image produced by process 200 or 300 is a modified version of its corresponding source image, where the new image may adhere closely to certain visual qualities of the source image. Thus, for example, a reformatted source image that is a digital advertisement for a company may maintain desired visual qualities (style, brand colors, etc.) that are associated with that company and its advertisements.

In some implementations, an indication of the desired aspect ratio may be provided as an input to the image generation process, e.g., process 200 and/or 300. In some implementations, the generative AI model 114 produces an image in a 1:1 aspect ratio (or another suitable, fixed aspect ratio) and computing system 102 prunes the intermediate image to the desired aspect ratio. In some implementations, the desired aspect ratio is input to the generative AI model 114 (in addition to the source image) and the generative AI model 114 chooses an intermediate aspect ratio based on the desired aspect ratio for the new image.

By using the disclosed techniques, the generative AI model 114 can more seamlessly change the aspect ratio of the source image. For example, the aspect ratio may seamlessly be changed from portrait to landscape or vice versa (e.g., without positioning objects in an aesthetically displeasing way due to the format change, and/or without stressing or minimizing features of the new image in a way that makes the new image perform poorly, etc.).

The processes 200 and/or 300 may include iterations for generating multiple new images from a single source image (e.g., each with a different aspect ratio), for example. Additionally or alternatively, in some implementations, the processes 200 and/or 300 include feedback mechanisms. For example, the computing system 102 may access data stored in quality and/or performance database 116 to determine the quality (e.g., as rated by human reviewers) and/or performance (e.g., based on actual performance and/or ML-predicted performance) of assets/images having different aspect ratios in a particular campaign or ad group, and automatically determine/select a new desired aspect ratio (i.e., for use with the “third” image of process 200 and/or 300) based on that quality and/or performance data.

The processes 200 and/or 300 may include one or more additional blocks not shown in FIG. 2 or 3. For example, the processes 200 and/or 300 may include a first additional block in which a user manually specifies an aspect ratio and/or a desired color palette for use in the third image. Additionally, the stages of processes 200 and/or 300 may occur in other orders, e.g., stages 315 and/or 320 may occur before stage 310.

As is apparent from the above description, techniques disclosed herein use artificial intelligence to generate images with different/new aspect ratios. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and finetuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 102 may use one or more of the machine learning models or techniques noted above to perform any one or more of the operations discussed herein in connection with machine learning. For example, the computing system 102 may use one or more such machine learning techniques to pre-train and/or finetune the generative AI model 114 and possibly to pre-train and/or finetune a model that predicts performance of an image (e.g., to generate additional feedback/inputs as discussed above), etc.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1: A computing system for reformatting a source image having a first aspect ratio, the computing system comprising: one or more processors; and one or more non-transitory memories having stored thereon computer-executable instructions that, when executed by the one or more processors, cause the computing system to: receive the source image; generate, based on the source image, an intermediate image having a second aspect ratio different from the first aspect ratio, wherein generating the intermediate image includes using a generative artificial intelligence model to expand the source image in at least one dimension; and generate a third image having a third aspect ratio different from the first aspect ratio and the second aspect ratio, wherein generating the third image includes pruning the intermediate image in at least one dimension.

Example 2: The system of example 1, wherein the second aspect ratio is a 1:1 aspect ratio.

Example 3: The system of example 1 or 2, wherein the first aspect ratio is a landscape aspect ratio and the third aspect ratio is a portrait aspect ratio.

Example 4: The system of example 1 or 2, wherein the first aspect ratio is a portrait aspect ratio and the third aspect ratio is a landscape aspect ratio.

Example 5: The system of any one of examples 1-4, wherein the computer-executable instructions further cause the computing system to, before generating the intermediate image: detect a salient region of the source image; and crop the source image based on the detected salient region.

Example 6: The system of any one of examples 1-5, wherein the generative artificial intelligence model is a masked generative image transformer model.

Example 7: The system of any one of examples 1-6, wherein: the computer-executable instructions further cause the computing system to determine that the source image does not have a solid color background; and generating the intermediate image is in response to determining that the source image does not have a solid color background.

Example 8: A computer-implemented method for reformatting a source image having a first aspect ratio, the method comprising: receiving, by one or more processors, the source image; generating, by the one or more processors and based on the source image, an intermediate image having a second aspect ratio different from the first aspect ratio, wherein generating the intermediate image includes using a generative artificial intelligence model to expand the source image in at least one dimension; and generating, by the one or more processors, a third image having a third aspect ratio different from the first aspect ratio and second aspect ratio, wherein generating the third image includes pruning the intermediate image in at least one dimension.

Example 9: The computer-implemented method of example 8, wherein the second aspect ratio is a 1:1 aspect ratio.

Example 10: The computer-implemented method of example 8 or 9, wherein the first aspect ratio is a landscape aspect ratio and the third aspect ratio is a portrait aspect ratio.

Example 11: The computer-implemented method of example 8 or 9, wherein the first aspect ratio is a portrait aspect ratio and the third aspect ratio is a landscape aspect ratio.

Example 12: The computer-implemented method of any one of examples 8-11, further comprising, before generating the intermediate image: detecting, by the one or more processors, a salient region of the source image; and cropping, by the one or more processors, the source cropped image based on the detected salient region.

Example 13: The computer implemented method of any one of examples 8-12, wherein the generative artificial intelligence model is a masked generative image transformer model.

Example 14: The computer implemented method of any one of examples 8-13, wherein: the computer-executable instructions cause the computing system to determine that the source image does not have a solid color background; and generating the intermediate image is in response to determining that the source image does not have a solid color background.

Example 15: One or more tangible, non-transitory computer-readable media storing instructions that, when executed by one or more processors, cause the one or more processors to: receive a source image having a first aspect ratio; generate, based on the source image, an intermediate image having a second aspect ratio different from the first aspect ratio, wherein generating the intermediate image includes using a generative artificial intelligence model to expand the source image in at least one dimension; and generate a third image having a third aspect ratio different from the first aspect ratio and the second aspect ratio, wherein generating the third image includes pruning the intermediate image in at least one dimension.

Example 16: The one or more tangible, non-transitory computer-readable media of example 15, wherein the first aspect ratio is a landscape aspect ratio and the third aspect ratio is a portrait aspect ratio.

Example 17: The one or more tangible, non-transitory computer-readable media of example 15, wherein the first aspect ratio is a portrait aspect ratio and the third aspect ratio is a landscape aspect ratio.

Example 18: The one or more tangible, non-transitory computer-readable media of any one of examples 15-17, wherein the instructions further cause the one or more processors to: detect a salient region of the source image; and crop the source image based on the detected salient region.

Example 19: The one or more tangible, non-transitory computer-readable media of any one of examples 15-18, wherein the generative artificial intelligence model is a masked generative image transformer model.

Example 20: The one or more tangible, non-transitory computer-readable media of any one of examples 15-19, wherein: the instructions further cause the one or more processors to determine that the source image does not have a solid color background; and generating the intermediate image is in response to determining that the source image does not have a solid color background.

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A computing system for reformatting a source image having a first aspect ratio, the computing system comprising:
one or more processors; and
one or more non-transitory memories having stored thereon computer-executable instructions that, when executed by the one or more processors, cause the computing system to:
receive the source image;
generate, based on the source image, an intermediate image having a second aspect ratio different from the first aspect ratio, wherein generating the intermediate image includes using a generative artificial intelligence model to expand the source image in at least one dimension; and
generate a third image having a third aspect ratio different from the first aspect ratio and the second aspect ratio, wherein generating the third image includes pruning the intermediate image in at least one dimension.

2. The system of claim 1, wherein the second aspect ratio is a 1:1 aspect ratio.

3. The system of claim 1, wherein the first aspect ratio is a landscape aspect ratio and the third aspect ratio is a portrait aspect ratio.

4. The system of claim 1, wherein the first aspect ratio is a portrait aspect ratio and the third aspect ratio is a landscape aspect ratio.

5. The system of claim 1, wherein the computer-executable instructions further cause the computing system to, before generating the intermediate image:
detect a salient region of the source image; and
crop the source image based on the detected salient region.

6. The system of claim 1, wherein the generative artificial intelligence model is a masked generative image transformer model.

7. The system of claim 1, wherein:
the computer-executable instructions further cause the computing system to determine that the source image does not have a solid color background; and
generating the intermediate image is in response to determining that the source image does not have a solid color background.

8. A computer-implemented method for reformatting a source image having a first aspect ratio, the method comprising:
receiving, by one or more processors, the source image;
generating, by the one or more processors and based on the source image, an intermediate image having a second aspect ratio different from the first aspect ratio, wherein generating the intermediate image includes using a generative artificial intelligence model to expand the source image in at least one dimension; and
generating, by the one or more processors, a third image having a third aspect ratio different from the first aspect ratio and second aspect ratio, wherein generating the third image includes pruning the intermediate image in at least one dimension.

9. The computer-implemented method of claim 8, wherein the second aspect ratio is a 1:1 aspect ratio.

10. The computer-implemented method of claim 8, wherein the first aspect ratio is a landscape aspect ratio and the third aspect ratio is a portrait aspect ratio.

11. The computer-implemented method of claim 8, wherein the first aspect ratio is a portrait aspect ratio and the third aspect ratio is a landscape aspect ratio.

12. The computer-implemented method of claim 8, further comprising, before generating the intermediate image:
detecting, by the one or more processors, a salient region of the source image; and
cropping, by the one or more processors, the source cropped image based on the detected salient region.

13. The computer-implemented method of claim 8, wherein the generative artificial intelligence model is a masked generative image transformer model.

14. The computer-implemented method of claim 8, further comprising:
determining, by the one or more processors, that the source image does not have a solid color background; and
generating, by the one or more processors, the intermediate image is in response to determining that the source image does not have a solid color background.

15. One or more tangible, non-transitory computer-readable media storing instructions that, when executed by one or more processors, cause the one or more processors to:
receive a source image having a first aspect ratio;
generate, based on the source image, an intermediate image having a second aspect ratio different from the first aspect ratio, wherein generating the intermediate image includes using a generative artificial intelligence model to expand the source image in at least one dimension; and
generate a third image having a third aspect ratio different from the first aspect ratio and the second aspect ratio, wherein generating the third image includes pruning the intermediate image in at least one dimension.

16. The one or more tangible, non-transitory computer-readable media of claim 15, wherein the first aspect ratio is a landscape aspect ratio and the third aspect ratio is a portrait aspect ratio.

17. The one or more tangible, non-transitory computer-readable media of claim 15, wherein the first aspect ratio is a portrait aspect ratio and the third aspect ratio is a landscape aspect ratio.

18. The one or more tangible, non-transitory computer-readable media of claim 15, wherein the instructions further cause the one or more processors to:
detect a salient region of the source image; and
crop the source image based on the detected salient region.

19. The one or more tangible, non-transitory computer-readable media of claim 15, wherein the generative artificial intelligence model is a masked generative image transformer model.

20. The one or more tangible, non-transitory computer-readable media of claim 15, wherein:
the instructions further cause the one or more processors to determine that the source image does not have a solid color background; and
generating the intermediate image is in response to determining that the source image does not have a solid color background.
